(19) United States
(12) Patent Application Publication
(10) Pub. No.: US 2003/0055795 A1
(43) Pub. Date: Mar. 20, 2003

(54) Computing postage based on parcel thickness

(76) Inventor: Robert Sesek, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/955,815

(22) Filed: Sep. 19, 2001

(51) Int. Cl. G06F 17/00

(52) U.S. Cl. 705/410

(57) ABSTRACT

Computing postage based on the approximate weight of a parcel derived from the measured thickness of the parcel. A postage computing system that includes a thickness gauge positioned to measure the thickness of a parcel, a postage meter positioned to apply postage to the parcel and a computer electronically connected to the thickness gauge and the postage meter. The computer is configured to access weight data for parcel media and packaging, compute the weight of the parcel based on thickness data received from the thickness gauge, access postal rates according to parcel weight, compute postage for the parcel and transmit the postage to the postage meter.

### FIELD OF THE INVENTION

The present invention is directed to computing postage based on the approximate weight of a parcel derived from the measured thickness of the parcel.

### BACKGROUND OF THE INVENTION

Metered mail is often posted by weighing individual parcels, computing the necessary postage based on the weight and then applying the postage to the parcel. Postage is typically applied to the parcel by printing the postage directly on the parcel or by printing the postage on a label and then affixing the label to the parcel. In some systems for processing bulk mail, the weight of each parcel in a group of identical parcels is approximated by weighing or computing the weight of the inserts and the envelope and then adding these weights. Postage is set based on the computed weight of each parcel. In another system for approximating the weight of a parcel, described in U.S. patent application Ser. No. 09/150,487 filed Sep. 9, 1998, a printing device accesses a database of weights for different types of print media and envelopes to compute the weight of the parcel. The printing device is programmed to determine the postage corresponding to a particular print job based on the weight of the paper or other print media that is used for that print job, the number of sheets printed and the envelope into which the sheets will be inserted for mailing. The present invention was developed in an effort to improve on existing techniques for approximating the weight of a parcel in postage computing systems.

### SUMMARY OF THE INVENTION

The present invention is directed to computing postage based on the approximate weight of a parcel derived from the measured thickness of the parcel. In one embodiment of the invention, a postage computing system includes a thickness gauge positioned to measure the thickness of a parcel, a postage meter positioned to apply postage to the parcel and a computer electronically connected to the thickness gauge and the postage meter. The computer is configured to access weight data for parcel media and packaging, compute the weight of the parcel based on thickness data received from the thickness gauge, access postal rates according to parcel weight, compute postage for the parcel and transmit the postage to the postage meter. In another embodiment, a method according to the invention includes detecting the thickness of a parcel that includes a print medium in an envelope or other packaging, accessing weight data for the print medium and the packaging, computing the weight of the parcel, accessing postal rates according to parcel weight, and computing postage for the parcel.

### DESCRIPTION OF THE DRAWINGS

FIG. 1 is a block diagram of a postage computing system according to one embodiment of the invention.

FIG. 2 is a block diagram of a postage computing system according to another embodiment in which a scanner is used to detect the size of a parcel and weight data is accessed through a network.

FIG. 3 is a schematic diagram illustrating another embodiment in which metal binders can be detected and factored into the weight of the parcel.

FIG. 4 is a perspective view of a postage computer according to another embodiment of the invention in which the thickness gauge, scanner, metal detector, processor and printer are integrated into a single unit.

FIG. 5 is a flow chart illustrating one method according to the present invention for computing postage based on the measured thickness of a parcel.

FIG. 6 is a flow chart illustrating another method that includes scanning the parcel to determine its size, detecting any metal binders in the parcel and computing the weight of the parcel based on thickness, size and any metal binders that are detected.

### DETAILED DESCRIPTION OF THE INVENTION

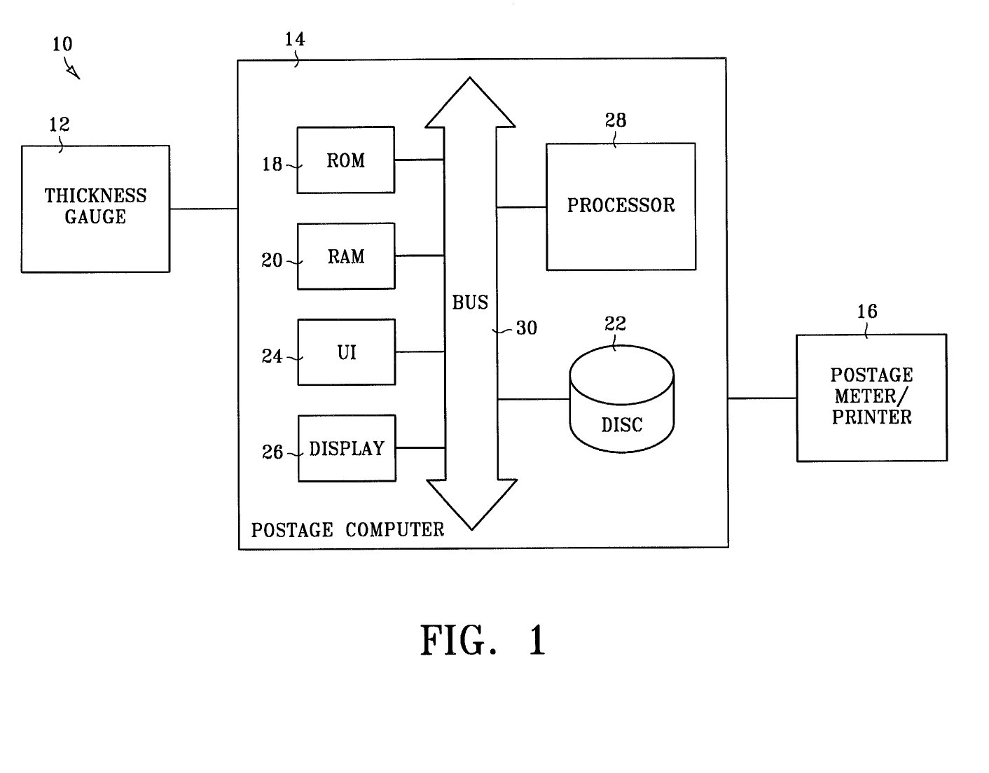

Referring to FIG. 1, postage computing system 10 includes a thickness gauge 12, postage computer 14 and postage printer 16. Although thickness gauge 12, computer 14 and printer 16 are shown in this block diagram as separate components, some or all of these components could be integrated into the same device. It is to be understood, therefore, that thickness gauge 12, computer 14 and printer 16 may be integrated components of a single device or separate components of a modular system.

Postage computer 14 includes several storage devices—read only memory (ROM) 18, random access memory (RAM) 20, and hard disk drive 22—each configured to store digital data that represents thickness measured by thickness gauge 12, media and envelope weight information, postage rates and related information, postage computation procedures and other necessary or desirable instruction and application components. Postage computer 14 also includes a user interface 24, display 26 and processor 28. Read only memory (ROM) 18, random access memory (RAM) 20, hard disk drive 22, user interface (UI) 24, display 26 and processor 28 are electronically interconnected through a bi-directional bus 30. User interface 24, a keypad or touch screen for example, in conjunction with display 26 enables local control of postage computer 14.

Thickness gauge 12 represents generally any device suitable for measuring the thickness of the types of parcels intended to be posted by system 10. Because system 10 relies on measuring the thickness of a parcel with sufficient accuracy to estimate postage, it is expected that the invention will typically be used with soft sided comparatively thin packages containing paper or other sheet media. A mechanical gauge is preferred to compress the parcel and thereby squeeze air out of the parcel before measuring its thickness to more accurately determine the thickness of the parcel.

The characteristics of the paper or other media contained in a parcel and the envelope or other packaging necessary to compute the weight of the parcel based on its thickness may be stored on computer 14, input by a user at the time postage is computed or electronically detected using any suitable media sensing techniques. The necessary characteristics will usually include the thickness and weight of each media sheet and the thickness and weight of the envelope. It is expected that the invention will have it greatest utility in mailing environments in which many parcels containing the same media and envelope are posted at the same time. In this environment, the necessary characteristics of all of the various media that might be contained in the parcels and the envelopes will be stored on disk 22. The appropriate characteristics are retrieved by processor 28 in response to a user command at user interface 24 identifying the media and the envelope or a predetermined media/envelope setting may be automatically invoked by processor 28 absent an overriding user command. In either event, when thickness data is received from gauge 12, processor 28 uses media and envelope weight/thickness data to compute the weight of the parcel and the required postage.

For example, a large law firm is sending out monthly bills. Some of the bills are long and consist of many sheets and some of the bills are short and consist of only one sheet. All of the sheets are printed on the same paper, A4 20# bond for example, whose weight and thickness per sheet is known. Tri-fold sheets are inserted into the same type of envelope, Dewey, Cheatum & Howe Law Firm Standard No. 1 for example, whose weight and thickness is also known. The user keys in to postage computer 14 a run of A4 20# bond tri-fold sheets in Standard No. 1 envelopes. The weight may be computed from an algorithm or a look-up table relating the thickness of the parcel to the number of sheets in the parcel and, hence, the weight of the parcel. Once the weight of the parcel is known, the appropriate postage is computed according to conventional rate calculation procedures and transmitted electronically or manually from postage computer 14 to postage meter/printer 16. Postage meter 16 represents generally any suitable printing device that applies the desired postage to a parcel. A conventional postage meter traditionally used in conjunction with a scale, for example, can be used with postage computer 14. Hence, the term meter or metering device as used herein refers generally to any device that will print or otherwise apply postage to the parcel.

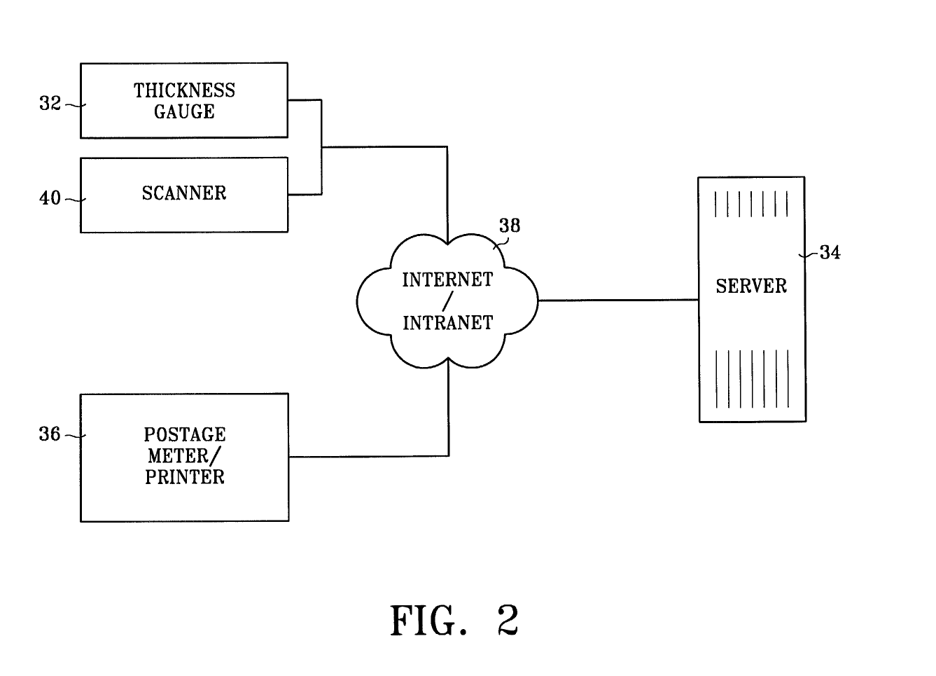

In an alternative embodiment of the invention shown in FIG. 2, a thickness gauge 32 is connected to server computer 34 and a postage meter 36 through a network 38. In this networked embodiment, all of the data processing and computational procedures can be performed at a location remote from the thickness gauge 32 and postage meter 36. A large corporation, for example, may have one central computer for computing parcel weight and postage based on thickness data received from any of its mail rooms or other offices around the world via the company's own intra-network or via the Internet. Subscription web sites might also be used to serve customers who do not wish to invest in the application software that computes weight and postage. In that case, thickness data is transmitted from the customer thickness gauge 32 to a web server 34 via the Internet 38 where the weight and postage is computed and transmitted to the customer at meter 36.

An optional scanner 40 or other measuring device may be used to detect the planar size of the parcel. The scanner detects the planar size of the envelope and, inferentially, the planar size of the media contained in the envelope. If the size of the envelope and media is detected with scanner 40, it is not necessary for the computer to know this size information in advance to compute weight and, therefore, postage from the thickness measurement. In the law firm example described above, the user need only key in a run of 20# bond tri-fold sheets. The scanner will detect the Standard No. 1 size envelope and the A4 size paper.

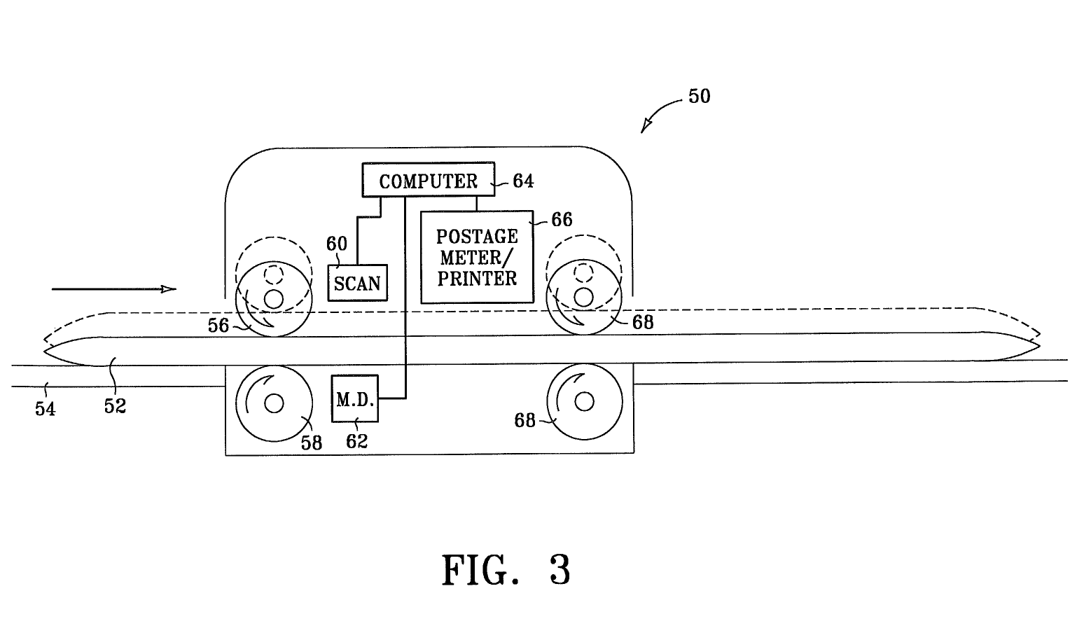

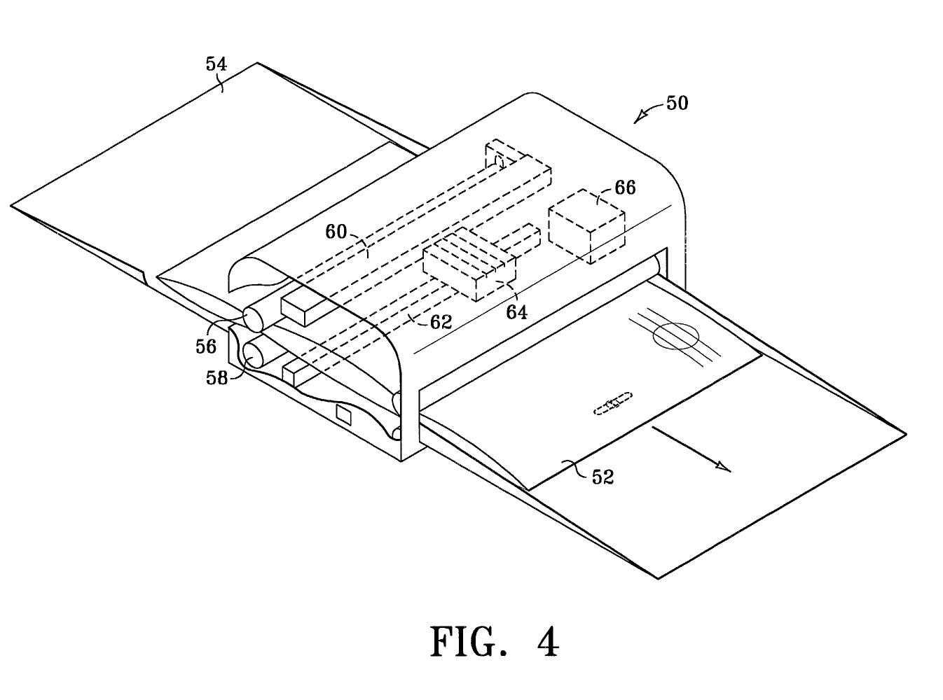

FIGS. 3 and 4 show another embodiment of the invention in which the thickness gauge, postage computer and meter/printer are integrated into a single unit, which is referred to generally as postage machine 50. User input may be received through a local control panel (not shown) or from a remote computer (not shown) electronically coupled to the unit. FIG. 3 is a block diagram of machine 50 and FIG. 4 is a perspective view showing one exemplary configuration of the components of machine 50. Referring now to FIGS. 3 and 4, a parcel 52 is received into postage machine 50 along tray or conveyor 54. Parcel 52 is drawn into machine 50 by a pair of feed rollers 56 and 58. Feed rollers 56 also function as the thickness gauge. As shown in FIG. 3, the top roller 56 is movable up and down in response to the thickness of parcel 52. Feed rollers 56 and 58 apply sufficient pressure to parcel 52 to squeeze the air out or away from the roller contact to accurately measure the thickness of the envelope and its contents that make up parcel 52. The thickness of the parcel is measured by detecting or sensing the amount of movement of top roller 56 away from bottom roller 58. A rotary thickness measuring mechanism such as the opposing rollers shown in the figures is only one example of a suitable thickness gauge. A linear thickness gauge, laser ranging device, and optical or acoustical sensors could also be used.

Feed rollers 56 and 58 convey parcel 52 past scanner 60 and metal detector 62. An optional metal detector 62 is shown in this embodiment to detect staples, paper clips and other metal binders that might be part of the contents of parcel 52. The data collected by thickness gauge 56/58, scanner 60 and metal detector 62 is transmitted to the on-board computer 64. Using this information, computer 64 computes the weight of parcel 52 and the required postage using the procedures described above. Computer 64 transmits the postage to meter 66 which applies the postage to parcel 52. A pair of output rollers 68 may be used if necessary or desirable to convey parcel 52 out of postage machine 50.

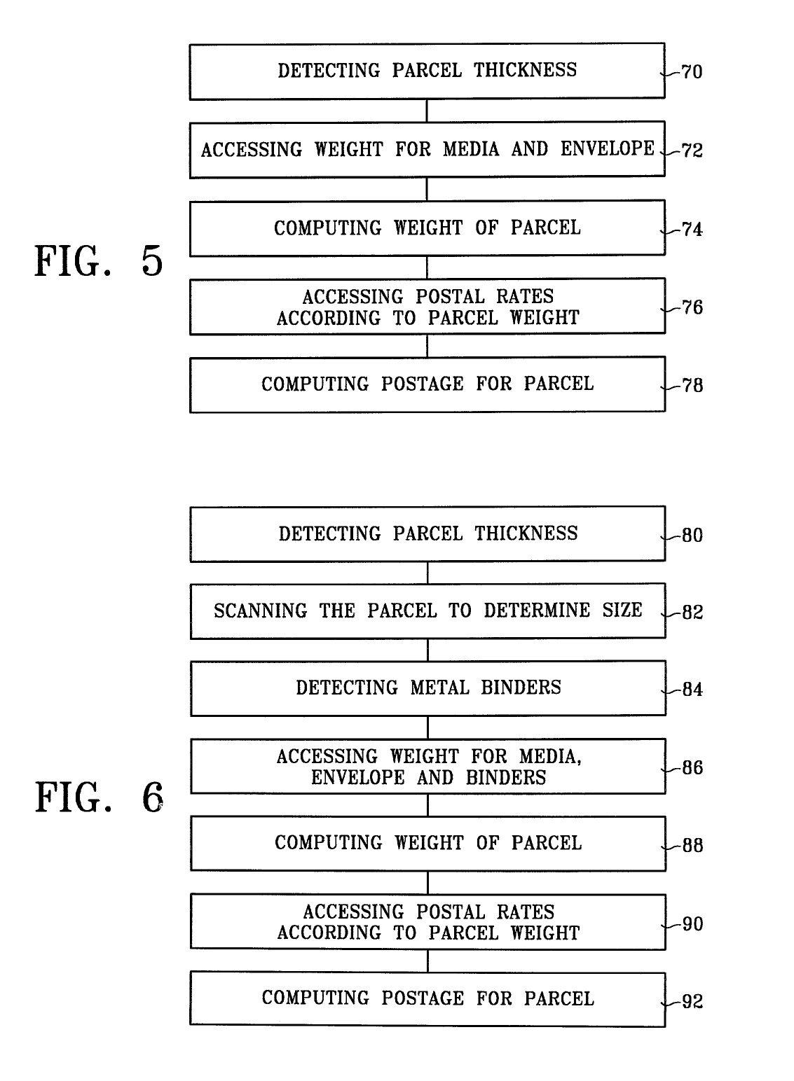

Exemplary methods for computing postage according to the invention are illustrated in the flow chart of FIGS. 5 and 6. The method of FIG. 5 includes: detecting the thickness of a parcel that includes an envelope and some type of media in the envelope (step 70); accessing weight data for the media and the envelope (step 72); computing the weight of the parcel based on its thickness (step 74); accessing postal rates according to parcel weight (step 76); and computing postage for the parcel (step 78).

Additional optional acts shown in FIG. 6 include scanning the parcel, detecting metal binders in the parcel and computing the weight of the parcel based on the size and thickness of the parcel and any metal binders that are detected in the parcel. Referring to FIG. 6, this alternative method includes: detecting the thickness of a parcel that includes an envelope and some type of media in the envelope (step 80); scanning the parcel to determine its size (step 82); detecting any metal binders in the parcel (step 84); accessing weight data for the media, envelope and the binders (step 86); computing the weight of the parcel based on its size and thickness and any metal binders in the parcel (step 88); accessing postal rates according to parcel weight (step 90); and computing postage for the parcel (step 92).

While the present invention has been shown and described with reference to the foregoing exemplary embodiments, it is to be understood that other forms, details, and embodiments may be made without departing from the spirit and scope of the invention which is defined in the following claims.

What is claimed is:

1. A method, comprising:
detecting the thickness of a parcel that includes a print medium in an envelope or other packaging;
accessing weight data for the print medium and the packaging;
computing the weight of the parcel;
accessing postal rates according to parcel weight; and
computing postage for the parcel.

2. The method of claim 1, wherein the print medium comprises a sheet print medium and accessing weight data comprises accessing data representing the thickness of each sheet of the print medium and the weight of each sheet of the print medium.

3. The method of claim 2, wherein accessing weight data further comprises accessing data representing a number of folds of the sheet print medium.

4. The method of claim 1, further comprising:
detecting a metal binder in the parcel; and
accessing weight data for the metal binder.

5. The method of claim 1, further comprising applying the postage to the packaging.

6. A method, comprising:
accessing postal rates according to parcel weight;
accessing weight data for different types of print media and different types of envelopes;
detecting the thickness of a parcel that includes one type of print media in an envelope;
computing the weight of the parcel; and
computing postage for the parcel.

7. The method of claim 6, further comprising:
accessing weight data for different types of metal binders; and
detecting at least one type of metal binder in the parcel.

8. The method of claim 6, further comprising applying the postage to the envelope.

9. A method, comprising:
accessing postal rates according to parcel weight;
detecting the size a parcel that includes one type of print media in an envelope;
accessing weight data for the print media and the envelope;
computing the weight of the parcel; and
computing postage for the parcel.

10. A method, comprising:
accessing postal rates according to parcel weight;
accessing weight data for different types of print media and different types of envelopes;
detecting the thickness of a parcel that includes one type of print media in an envelope;
scanning the parcel to determine its planar size;
computing the weight of the parcel based on the thickness and size of the parcel; and
computing postage for the parcel.

11. A postage computing system, comprising:
a thickness gauge positioned to measure the thickness of a parcel;
a postage meter positioned to apply postage to the parcel; and
a computer electronically connected to the thickness gauge and the postage meter, the computer configured to access weight data for parcel media and packaging, compute the weight of the parcel based on thickness data received from the thickness gauge, access postal rates according to parcel weight, and compute postage for the parcel.

12. A postage computing system, comprising:
a thickness gauge positioned to measure the thickness of a parcel;
a postage meter positioned to apply postage to the parcel; and
a computer electronically connected to the thickness gauge and the postage meter, the computer configured to access weight data for parcel media and packaging, compute the weight of the parcel based on thickness data received from the thickness gauge, access postal rates according to parcel weight, compute postage for the parcel and transmit the postage to the postage meter.

13. The system of claim 12, further comprising a metal detector electronically connected to the computer, the metal detector positioned to detect metal in the parcel, and wherein the computer is further configured to access weight data for metal binders and compute the weight of the parcel based on thickness data received from the thickness gauge and metal data received from the metal detector.

14. The system of claim 12, further comprising a scanner electronically connected to the computer, the scanner positioned to detect the planar size of the parcel, and wherein the computer is further configured to compute the weight of the parcel based on thickness data received from the thickness gauge and size data received from the scanner.

15. A computer program product for computing postage, the product comprising a computer useable medium having machine readable instructions thereon for:
receiving data representing the thickness of a parcel;
accessing weight data for parcel media and packaging;
computing the weight of the parcel;
accessing postal rates according to parcel weight; and
computing postage for the parcel.
